(19) United States
(12) Patent Application Publication
(10) Pub. No.: US 2006/0278291 A1
(43) Pub. Date: Dec. 14, 2006

(54) Pipe element, especially for exhaust pipes in motor vehicles, and method for producing the same

(76) Inventors: Dietmar Baumhoff, Sieg (DE); Marcus Hupertz, Wend (DE); Frank Bender, Drolshagen (DE); Stefan Hauk, Hilchenbach (DE); Karl-Heinz Muncker, Hilchenbach (DE); Gunter Hupertz, Wenden (DE); Manfred Fuhrmann, Hilchenbach (DE); Matthias Weiss, Hilchenbach (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/539,701

(22) PCT Filed: Dec. 18, 2003
(86) PCT No.: PCT/DE03/04184

§ 371 Date: Jun. 16, 2005

(30) Foreign Application Priority Data
Dec. 18, 2002 (DE) 10259695.6
Dec. 19, 2002 (DE) 10260256.2
Apr. 11, 2003 (DE) 10316985.7

(51) Int. Cl. F16L 11/00

(52) U.S. Cl. 138/135; 138/171

(57) ABSTRACT

The invention relates to a method for producing a pipe element (1) for pipes that are subject to vibrating stress, especially for exhaust pipes in motor vehicles. Said pipe element consists of a preprofiled strip (2; 3), especially a metal strip, that is wound in convolutions with bellow-shaped windings (4; 22). The wound layers produced by a strip width are interlinked in a single-hooked or multi-layer clasp-type bond (9; 19) by positive locking, welding or similar joining methods. The Strip (2; 3) is preprofiled with at least one stitch that is off-set from the plane by deflection into a kind of circuit with web heights (h1, h2) of the bellows (4; 22) that are multiples of the strip thickness.

The invention relates to a method of making a conduit for vibration-stressed conduit systems, in particular as a motor-vehicle exhaust pipe, from a preshaped strip, in particular a metal strip, that is helically wound with bellows-like folds, the wound-together layers formed by a strip width having singly hooked-together or multilayer interlocked edges joined by interfitting, welding, or a similar joining process and to a conduit produced according to the method.

The goal of such conduits, that are wound as spiral-shaped wound interlocked tubes or spiral-shaped interhooked tubes, that typically leak a little in use, is to connect vibrating pipes to each other so as to decouple them with respect to vibration. An element of such a conduit is in many cases a metall bellows. Since the large difference in diameters in the folds of the bellows create turbulence, as a rule a metal hose is integrated into the conduit so as to ensure laminar exhaust-gas flow. To this end attention must be paid that during the use there is no noise generated by engagement of the metal hose inside the bellows. In order to achieve this and gas tightness, in many case a wire mesh surrounds the hose. German 198 20 863 describes a flexible conduit wherein alternatively to a wire mesh the metal hose and the metal bellows are fixed together at specific locations.

The known embodiments require different manufacturing processes for the individual elements as well as expensive s positioning and assembly operations. Since, in addition to the manufacturing of the individual parts of the described conduits the assembly process is expensive, it has been proposed for economic reasons to manufacture the metal bellows and the internal hose in a single manufacturing process by helical winding. Such a manufacture so-called exhaust hose is known from German 38 09 210. The there described helical winding of a preshaped metal strip has however two disadvantages. On the one hand the conduits is not completely gas tight. On the other hand the geometric shape of the bellows-like corrugations produced on manufacture of the bellow and hose from a preshaped metal band is subject to substantial limitations, so that it is not possible in many cases to attain the desired static and dynamic stiffness required. This problem is caused by the considerable axial and radial deformation of the hose and bellows parts relative to each other, since during winding the different dimensions of a preshaped metal strip are limited strongly by the production limits of forming the bellows folds with the desired geometric relationships.

German utility model 76 31 806 discloses a corrugated hose formed in one or more layers by helically winding a profiled strip or interfitted preshaped tubular sections of metal or plastic with gas-tight strip or tube edges joined together by interfitting, welding, gluing, or the like. For the best possible laminar gas flow the inner strip or tube edge is unitarily connected with an axially extending tubular extension that inwardly covers at least the adjacent bumpy helical or annular space.

It is an object of the invention to provide a method and a conduit of the above-described type whereby a one-step manufacturing process without subsequent assembly produces a geometrically so constructed conduit that a simple vibration-responsive product is achieved with the necessary static and dynamic stiffness.

This object is achieved according to the invention with a method wherein the strip is preshaped into an arcuate shape with webs heights of the bellows-shaped folds that are a multiple of a strip thickness. As many tests have confirmed, by not using the conventional planar-path roller-shaping method and instead using at least one roll stand outside the plane by arrangement of roller pairs on a spiral-shaped path whose curvature increases up to nearly the curvature of the conduit, it is possible to preshape the strip with transversely projecting webs that are 25 to 75 times bigger than the strip thickness. With a standard web thickness of 0.2 mm or 0.3 mm the web height can be 5 mm to 7.5 mm or 15 mm to 22.5 mm. According to preferred suggestions of the invention, the radially inwardly and preferably radially outwardly projecting webs with a fold height much greater than the known systems produce a conduit of great flexibility and elasticity. A spiral shape, produced by rolling outside a plane, in the final shape is advantageous from a shaping point of view because it increases the ability to flex without material failure so that large variations in shape and bellows-like turns or folds of different geometry or configuration can be produced. The turns or bellows folds are not point symmetrical but wave like, with a helical shape symmetrical to an axis.

According to an embodiment of the invention, one strip edge of one winding layer covers a valley of an adjacent bellows-like fold. As a result of this construction, good laminar flow is possible.

Preferably according to the invention at least two geometrically different strips are wound together, one strip forming a gas-conducting tube and the other strip forming bellows folds. Alternatively it is possible to feed multilayer flat metal strips to the production process and provide it with the bellows-like folds. The layering makes possible a linear distribution of the bending stresses and improves acoustic sound damping. In any case the metal strips can have different thicknesses, widths, mechanical properties, and chemical makeups so that the different requirements can be imparted to the geometry of the tube and bellows. Even elastomeric, glass-fiber-reinforce, or ceramic strips or belts of laminates, compounds, or composite workpieces can be employed. The strips, regardless of type and whether having one or more layers, are wound in each other and fitted together such that in ideal situations a gas-tight joint is produced where they meet.

According to an embodiment of the invention the strips are initially continuously roller shaped while parallel, then are deformed and pressure wound, and then the roller-shaped and wound strips are joined together. Alternatively the strips are sequentially and discontinuously roller shaped, then wound together under pressure, and subsequently the roller-shaped and wound strips are joined together. The parallel roller-shaping allows a continuous winding process and the sequential roller shaping is for a batch-type winding process.

The winding, preferably done with rollers on a mandrel, can take place preferably continuously so that the finished conduit after winding and fitting together runs off a rotating mandrel. When a long mandrel is completely wound with the conduit, according to a batch process, fixed lengths of the conduit are pulled off the long mandrel. To connect the strips, it is possible to deform them together, for example by folding or crimping, or to use thermal processes, for example beam or laser-beam welding or roller welding.

According to an embodiment of the invention the edges of the strips (2 and 3) to be joined are deformed to simplify the separation and further treatment and for locally homogenizing the product diameter. It is particularly advantageous when the connection ends are pressure treated.

Instead of making the folds or bellows-like turns of one piece from one fold, they can be made advantageously by joining, either deforming together or thermally joining, the edges of webs projecting from the edges of the trailing edge of one turn and the leading edge of another turn. It is also possible to form leading and trailing edges of one turn and to join the free web edges together. It is also possible to make more than two webs and join them together.

A preferred embodiment provides that a bell-shaped inner bellows fold is wound in a valley of an outer bellows fold with diametrally extending webs projecting from a common bridge and connecting web. The facing bellows folds fitting almost in each other produce a very soft decouplable configuration with considerable flexibility and elasticity. Since in the same length is it is possible to fit twice as many turns or folds, the conduit is nearly twice as flexible as it has more turns and folds. The shapes can be produced preferably symmetrical, so that the second strip has as a result of the folded-over bridge or connecting web a liner function, e.g. for laminar gas flow.

Gas tightness is achieved preferably in that upper free web edges of the bell-shaped inner bellows fold are connected to adjacent web edges of the outer bellows fold.

It is suggested that in order to separate the conduit into standard lengths and/or to shape and join them support means are used. The employed support means, e.g. an ultrasound overlay, make it possible when very long conduits are being produced, it is possible to make up the desired standard length using mechanical or, preferably, thermal cutting systems.

A further advantage embodiment is that the finished conduit is conditioned for the required static and dynamic stiffness. This can be done by subjecting, for example, the conduit to the effects of internal pressure or mechanical deformation.

A conduit made according to the invention is characterized in that it is formed with bellows folds having heights equal to a multiple of a strip thickness, preferably 25 to 75 times the thickness of the strip.

An embodiment of the invention proposes that at least two geometrically different strips are wound together, one strip forming a gas-conducting tube and the other strip forming the bellows folds. The gas-conducting tube serves for laminar gas flow and the very tall bellows folds give the conduit flexibility and elasticity.

Here preferably each bellows fold has a peak formed from the start as a closed turn. Advantageously each bellows fold can be formed by webs projecting radially from the turns and having free edges that are connected gas-tight together at the peak. Thus for example by doubling the winding layer each leading edge region of one turn forms with the trailing edge region of the preceding turn a bellows fold, so that joining together the outer edges of these edge regions seals the bellows fold.

When the hooked-together interlock connections are axially slidable in each other, the conduit has considerable axial play for extension and compression.

According to an embodiment of the invention the valleys of the bellows folds are covered by strip regions of the turns. This covering can be effected by a horizontal end region of one turn or between the hooked or interlocked sections of a turn layer.

According to a preferred embodiment of the invention a tube-base forming strip is formed with bell-shaped bellows folds that are each fitted in a bellows fold of the other strip, free web edges of the outer bellows fold being joined at the peak with the free edges of the inner adjacent webs of the bell-shaped bellows fold that covers the valley of the outer bellows fold with a connecting region between its webs. The outer bellows fold containing the facing inner bell-shaped fold produces a very soft configuration of a highly elastic and flexible conduit. The symmetrical shape achieved in spite of the different strips has substantial process advantages.

Further features and particularities of the invention are seen in the claims and the following description of embodiments of the invention shown in the drawing. Therein:

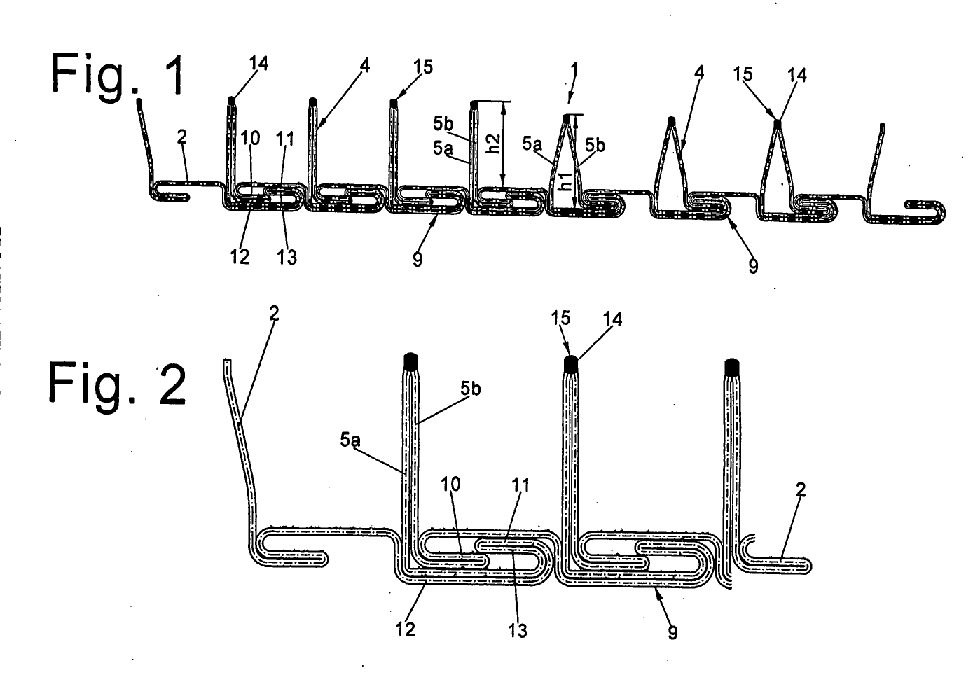

FIG. 1 is a sectional view of several turns of a conduit or tube made from a strip in an embodiment of a single-layer interlocked tube with unitary radially projecting webs, compressed together on the left and stretched out in the right half of the view;

FIG. 2 is a detail of FIG. 1 in larger scale showing the compressed-together condition of the interlocked tube;

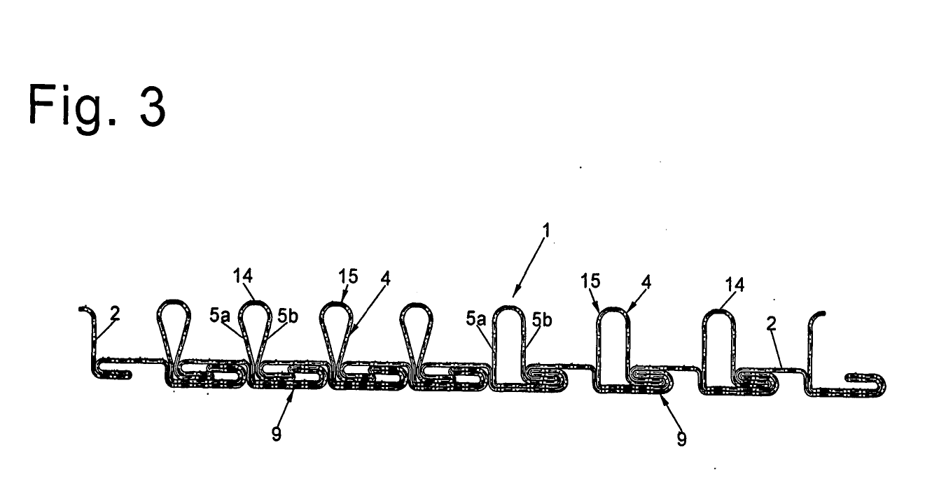

FIG. 3 is a view like that of FIG. 1 of a different embodiment of a single-layer interlocked tube;

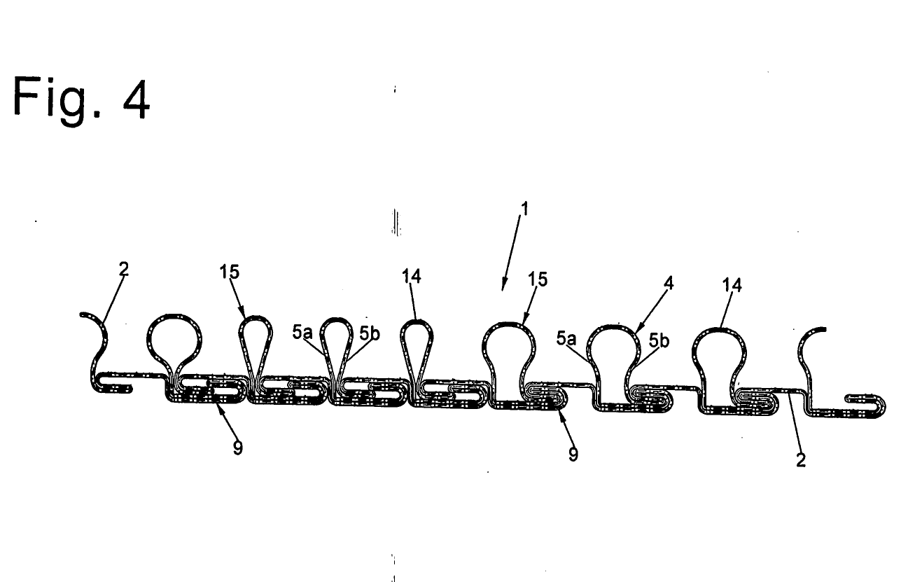

FIG. 4 is a view like that of FIG. 1 of a further embodiment of a single-layer interlocked tube;

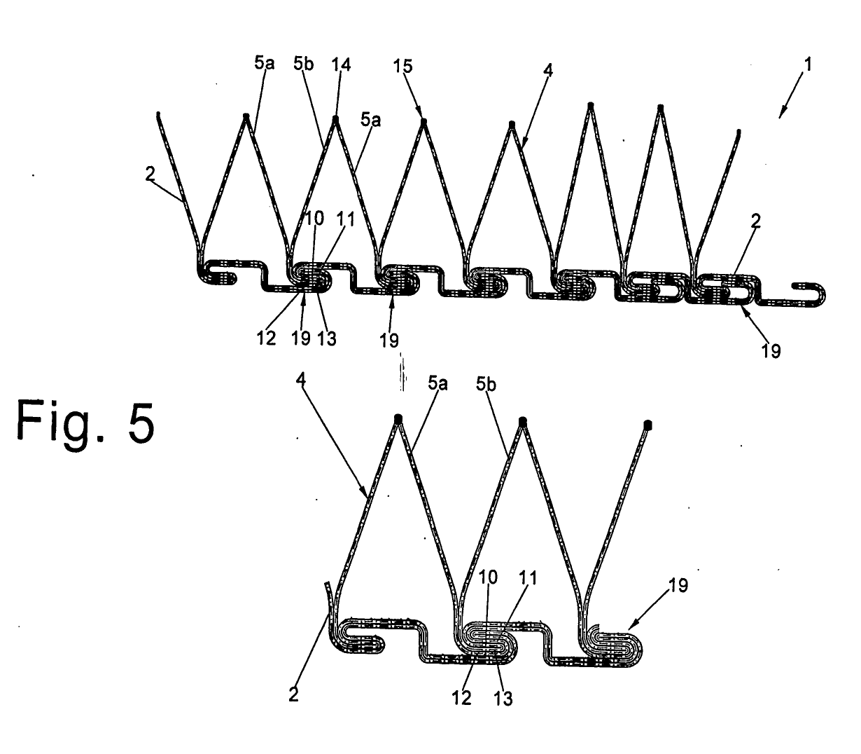

FIG. 5 is views like those of FIGS. 1 and 2 but of a multiple-layer interlocked tube and with the conduit or exhaust tube compressed together in the right half of the view;

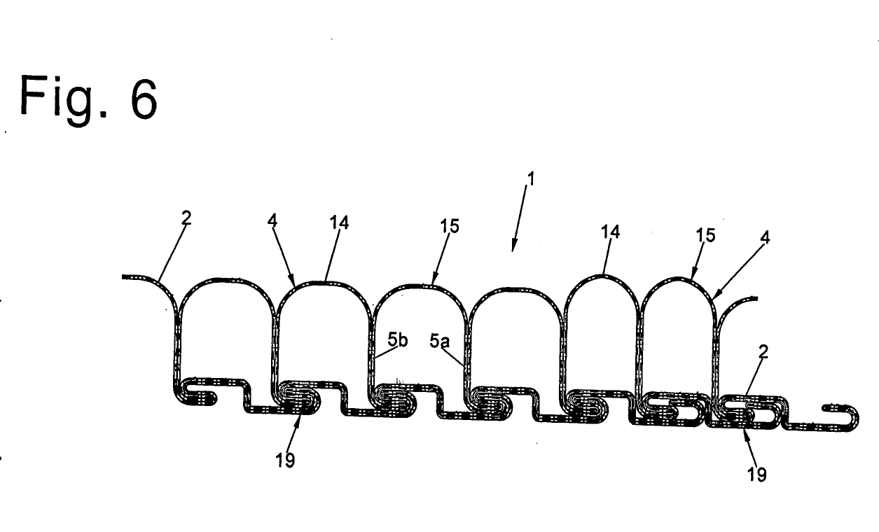

FIG. 6 is a view like FIG. 5 with differently shaped turns or bellows folds;

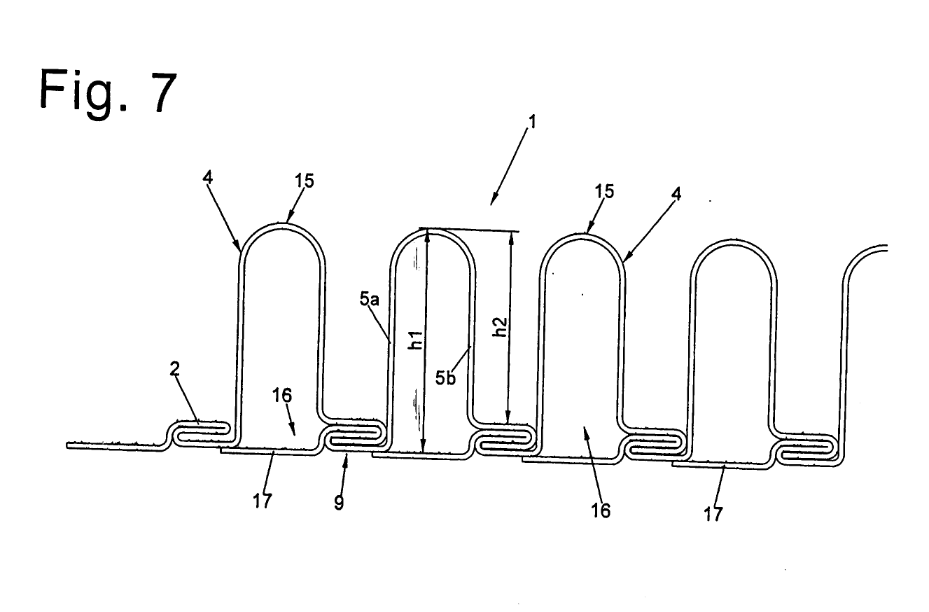

FIG. 7 is a sectional view of several turns of a conduit or tube made from strip whose bellows folds have inner crests, that is formed of closed folds or turns;

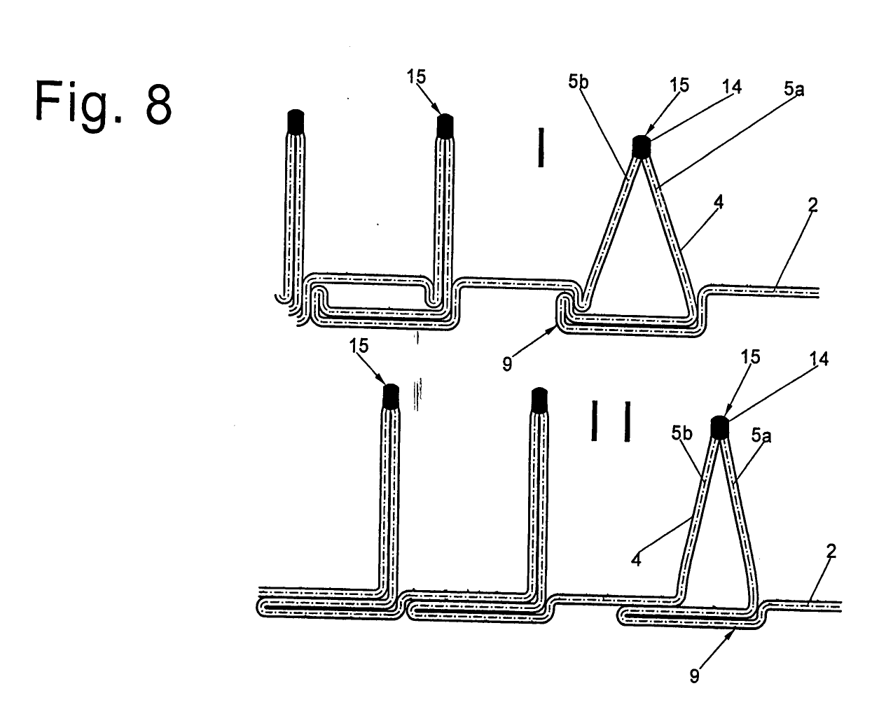

FIG. 8 is sectional views of further embodiments of a gas-tight conduit or tube in compressed and stretched condition with captured (I) or multilayer (II) turns;

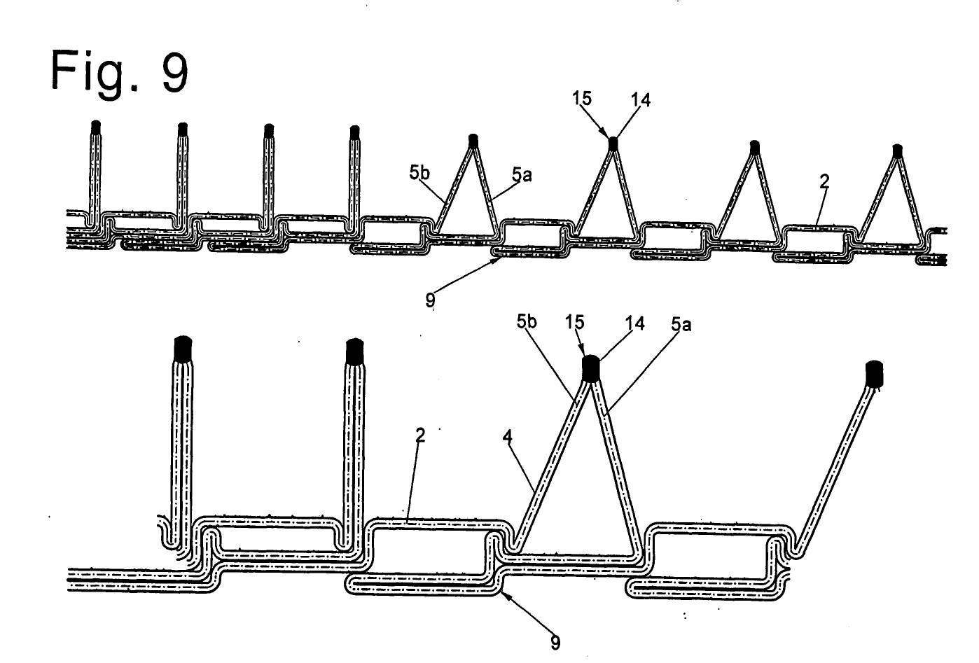

FIG. 9 is a sectional view of several turns of a conduit or tube in a central region with captured turns, shown in compressed condition (upper left half of view) and stretch condition (upper right half of view and enlarged in half of view);

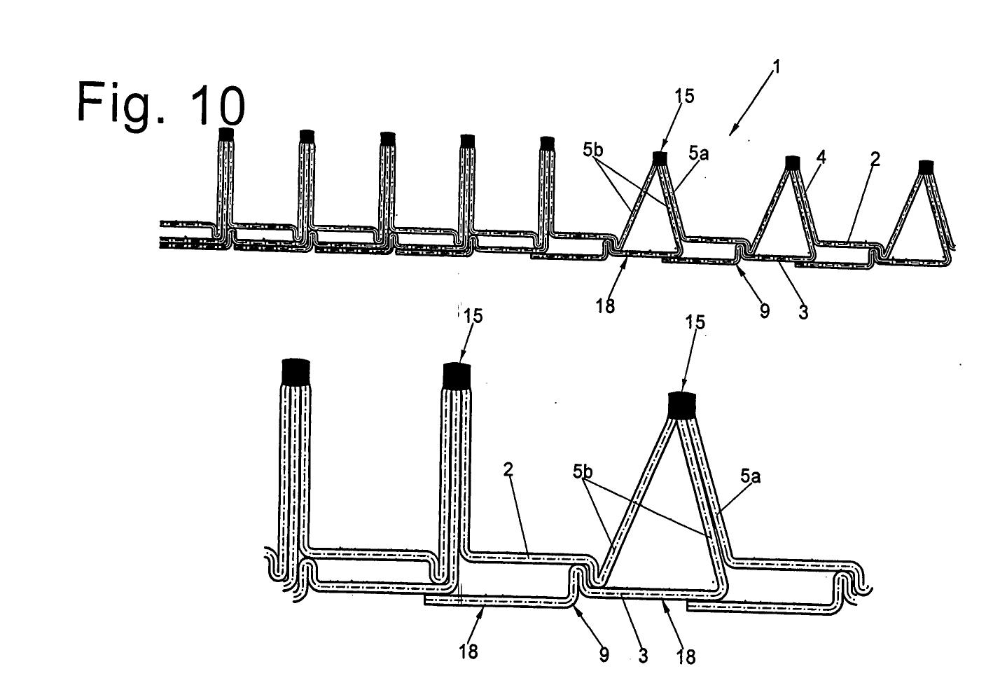

FIG. 10 is a sectional view of several turns of a conduit or tube in an embodiment of construction from two preshaped strips that are hooked together in a central region, shown in compressed condition (upper left half of view) and stretch condition (upper right half of view and enlarged in lower half of view);

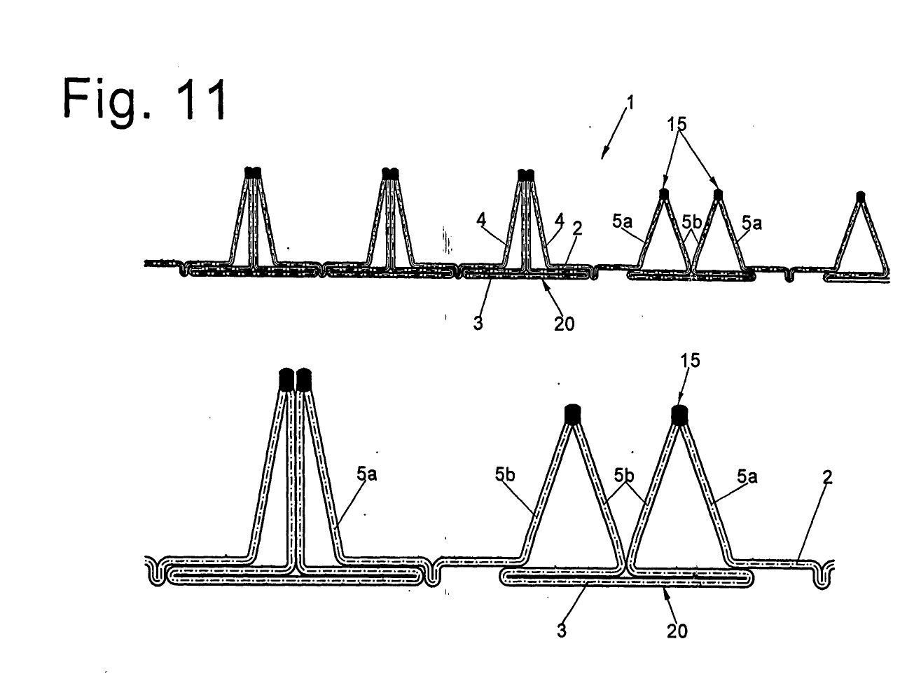

FIG. 11 is a view like FIG. 9 of another embodiment formed of two preshaped strips wound into a conduit or tube;

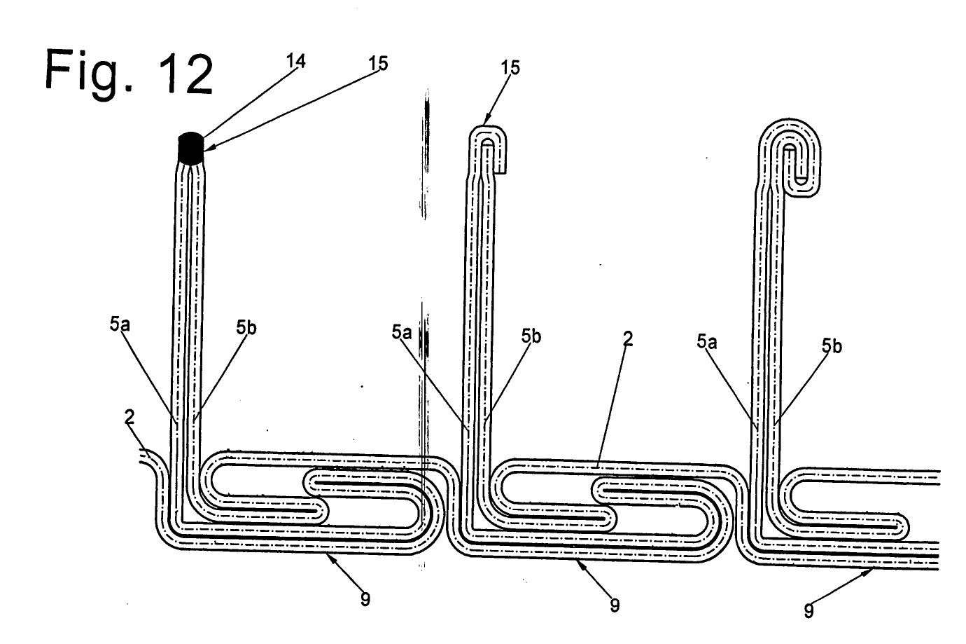

FIG. 12 is a detail in section of further embodiments with unitary or fitted together joints of adjacent radially outwardly projecting webs of preformed bellows folds or turns;

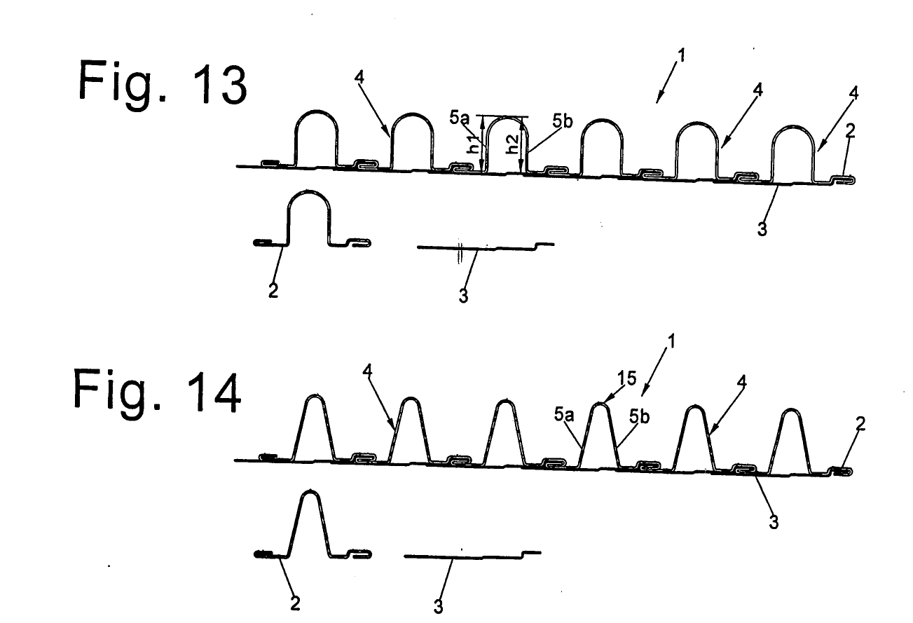

FIG. 13 is a section through several turns of a conduit or tube made of two strips, the inner tube producing a laminar-flow tube surface and the outer tube forming the bellows folds or turns;

FIG. 14 is a view like FIG. 13 with different folds or turns;

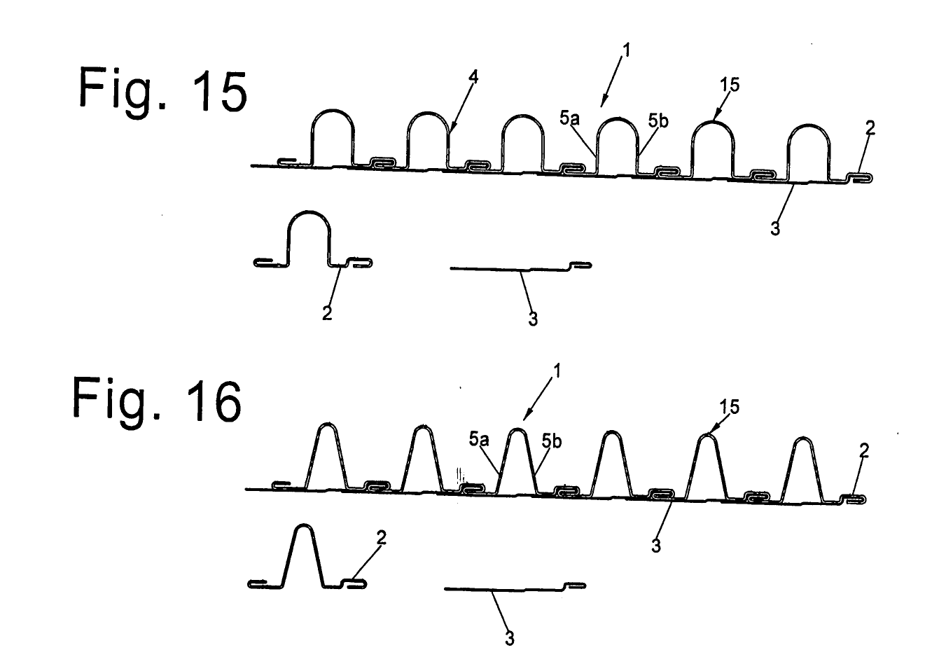

FIG. 15 is a view like FIG. 13 with an other system for hooking together the two tubes;

FIG. 16 is a view like FIG. 14 with different connections for hooking one strip to the other strip;

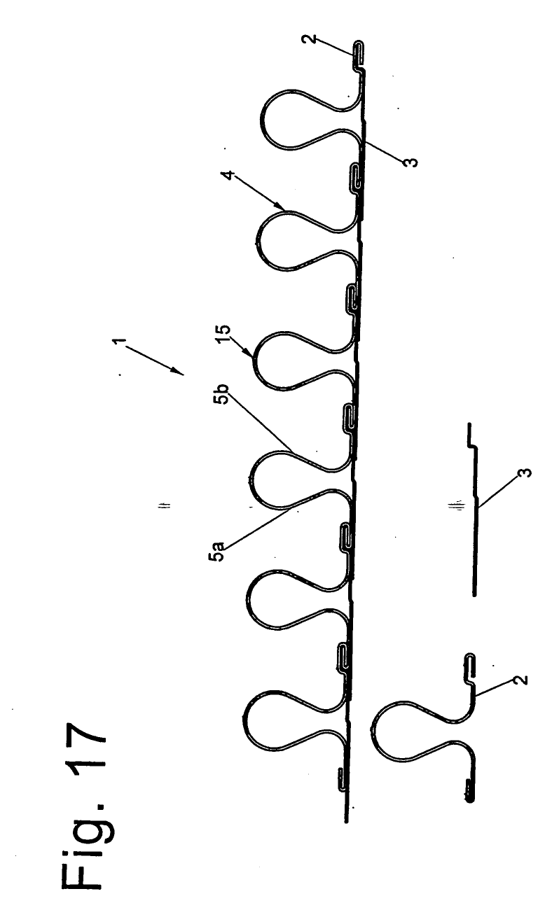

FIG. 17 is a view like FIG. 13 with another style of strip forming bellows folds or turns;

FIG. 18 is a view like FIG. 13 with a weld joint between the two tubes;

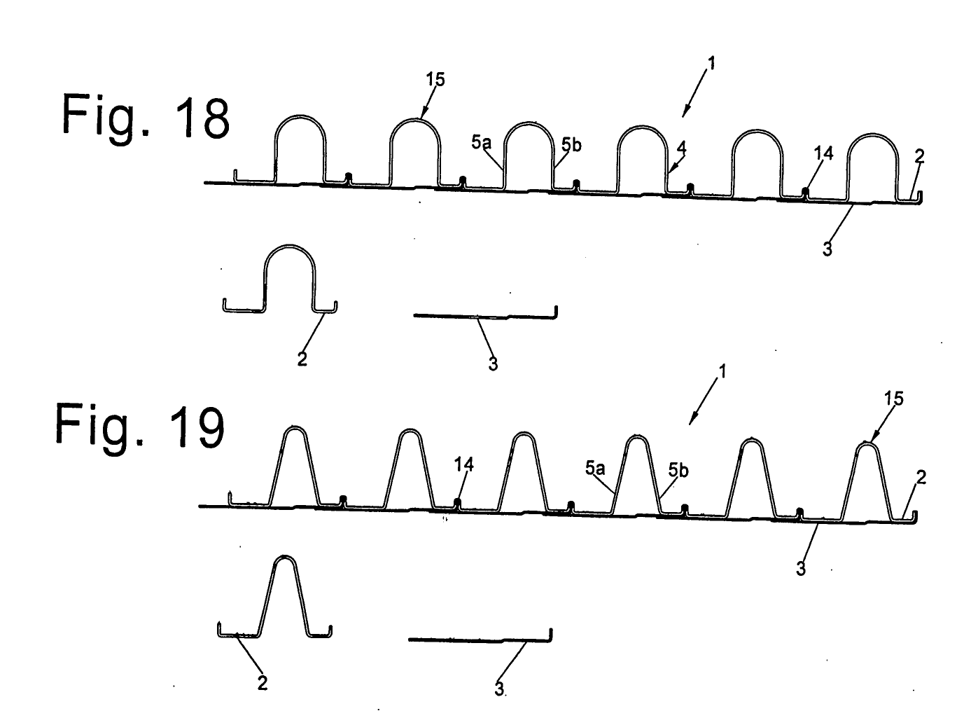

FIG. 19 is a view like FIG. 14 with a weld joint between the two tubes;

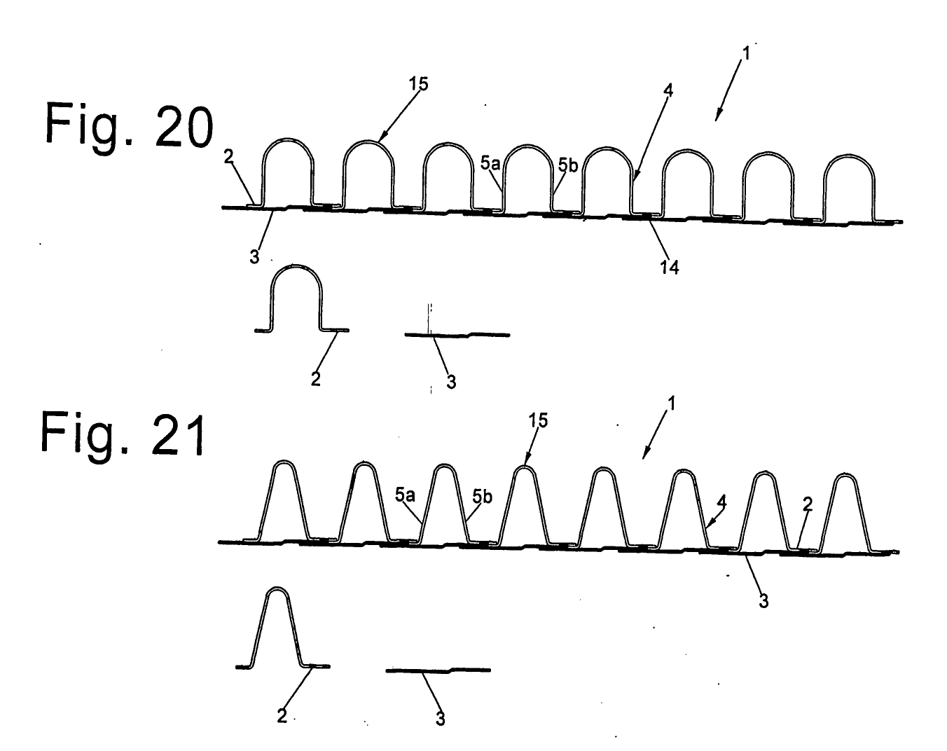

FIG. 20 is a view like FIG. 18 with a different weld connection;

FIG. 21 is a view like FIG. 19 with a different weld joint between the strips;

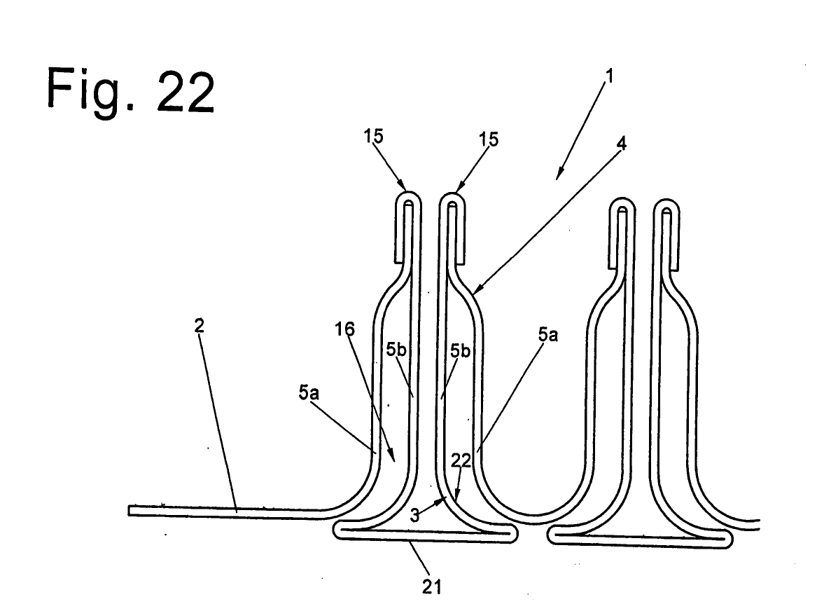

FIG. 22 is a section through an embodiment of a conduit or tube formed of two strips, where nested-together bellows folds formed by the folds or turns form a sort or bell; and

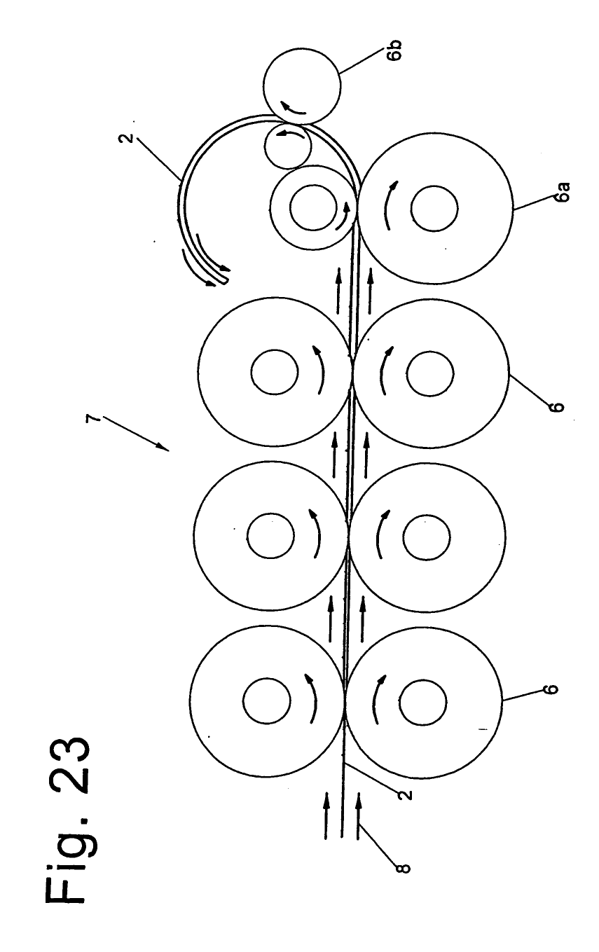

FIG. 23 is a schematic view of a profile-rolling system to preshape a strip with a formation projecting from its plane.

All the conduits or hoses 1 shown in section in FIGS. 1 to 22 have in common, whether they are formed of one strip 2 (FIGS. 1 to 9) or two strips 2 and 3 (FIGS. 10 and 11 and 13 to 22) or have one or several layers, that the strip 2 or the strips 2 and 3 have preformed bellows-like turns or folds 4 with a height h1 or h2 of the bellows folds 4 formed by radially inwardly or outwardly directed webs 5a and 5b and of a height equal to between 25 and 75 times the thickness of the strip 2 or 3 (see FIGS. 1, 7 and 13). To preshape these webs 5a and 5b or the bellows folds 4, the strip 2 is passed as shown in FIG. 23 between pairs of rollers 6 of a roller-shaping system 7 that has at least one pair of rollers not in the roller plane, to which end relative to the treatment direction 8 shown in the drawing the last roller pair 6a is somewhat lower. The strip 2 in the illustrated embodiment passes through another roller pair 6b situated on an arcuate path. The thus preshaped strip is wound together in a winding operation as an endless helix to form a hose.

The conduit shown in FIGS. 1 to 4 is formed of turns with single hooked-together connections 9. With this shape the trailing end regions 10 and the leading regions 11 are folded over to double-layer zones 12 and 13 that in the embodiments are set outward so that the webs 5a and 5b project radially. The upper free ends of the webs 5a and 5b are connected gas-tight together, as by weld seams 14, so as to form a closed bellows fold 4. As can be seen in the drawing, the preshaping can impart different shapes or geometries to the webs 5a and 5b so that in the stretched condition as shown in FIG. 1 they form a point or roof, in FIG. 3 are U-shaped, and according to FIG. 4 are rounded or omega-shaped, the omega shape having shown itself to be particularly durable.

In the conduits of FIGS. 5 and 6 there are multiple interlocked layers, the individual turns being connected together at an interlock 19. The trailing edge region 10 and the leading edge region 11 of the strip are also doubled at regions 12 and 13 that form outwardly bent webs 5a and 5b. With this interlock 19 nothing can get between the joints from outside. The free edges of the webs 5a and 5b are as in the above-described embodiments joined together after the winding operation, e.g. by roller welding, with a weld seam 14. Beam welding can be used as an alternative, as it requires no support. The shape or contour of the projecting webs 5a and 5b and thus of the bellows folds 4 is selected as for all embodiments that the necessary stiffness and static and dynamic resistance to vibration are achieved.

The conduit 1 made of a strip according to FIG. 7 has rounded bellows folds 4 of bellows-like turns that are preformed into closed turns, that is the webs 5a and 5b are not joined at crests 15. The hooked-together connection 9, which is produced by pressing or that can be welded together against an internal mandrel, causes the edge region 17 of each turn to extend over and cover the open bottom 16 of the adjacent bellows fold 4 for laminar gas flow.

FIGS. 8, 9, and 12 show further possible variants of the interlocks 9 and 19 of the individual turn layers in conduits 1 formed as described above of a strip 2 with radially projecting webs 5a and 5b joined by shaping or thermally joined together to form bellows folds 4. According to FIG. 8, the single hooked-together connection is shown at I, the multiple hooked-together connection at II, and a central hooked-together region in FIG. 9. FIG. 12 shows embodiments of the connection of the free ends of radially extending webs 5a and 5b, to the left joined by welding and in the center and to the right by crimping together.

Unlike the above-described embodiments the conduits 1 of FIGS. 10 and 11 are each formed by two strips 2 and 3 that are wound together. Both the inner and the outer strips have outwardly projecting webs 5a and 5b, the webs 5b of the inner strip 3 being connected with the adjacent webs 5a of the outer strip 2 to form gas-tight bellows folds 4. A variation is shown in FIG. 10 where in each turn of the outer strip 2 spaced webs 5a and 5b are paired with one web 5a of the inner strip 3, and the free edges of all these webs are connected together (by welding) at peaks 15. The individual turns are connected together at a hook connection 9 in the centers. Generally horizontal edge regions 18 of the inner strip 3 impart to the conduit 1 the desired shape for laminar gas flow. This is also achieved in the conduit 1 of FIG. 11 in that the strip section 20 between the folded webs 5b forms the desired hose shape.

Further conduits 1 formed of two strips 2 and 3 are shown in FIGS. 13 to 21 where the inner strip 3 provides the tube geometry for laminar gas flow and the outer strip 2 has the bellows folds in which the webs 5a and 5b form seamless, that is closed, peaks. The figures show the different possible shapes for the bellows folds 4. Furthermore the lower halves of the figures separately show the outer strip 2 and the inner strip 3 and the various ways of connecting the turns according to the preshaping of the strips 2 and 3. FIGS. 18 to 21 show that instead of fitting together and thereby coupling the individual layers it is possible to join them thermally by a weld seam 14.

A particular embodiment of a conduit 1 formed of two preshaped strips 2 and 3 is shown in FIG. 22. The radially symmetrically projecting webs 5a of the outer strip 2 are connected to the webs 5b at their outer free edges with the free edges of the inner strip 3 forming the hose base, with the folded-over connecting web 21 covering the valley 16 of the bellows fold 4 formed by the webs 5a. The outer bellows fold 4 closes an inner bellows fold 22 formed by the strip 3 and opening toward it, so that the combination of the outer bellows fold 4 and the inner bellows fold 22 forms a bell-like shape. In this embodiment the free edges of the webs 5a and 5b are joined together by folding; similarly the fold apices 15 could be joined or connected thermally. The bell shape of the bellows-like turns 4 and 22 forms the same overall dimension as a double-turn arrangement and thus imparts considerable flexibility and elasticity to the conduit 1.

In every case the conduit 1 is produced in a single production step by spiral winding. The rolling method to make the very tall webs or bellows folds or bellows-like turns, the deforming method, the mechanical or thermal jointing by means of which the webs are joined together gas-tight can take place in a continuous process or in a batch process. The resultant conduit is not only perfectly gas tight, but as a result of the deep bellows folds or turns is extremely flexible and elastic and profiles and gives good laminar gas flow regardless whether the conduit is formed from one strip or two or more strips in one or more layers.

1-24. (canceled)

25. A method of making a conduit (1) for vibration-stressed piping systems, in particular as a motor-vehicle exhaust pipe, from a preshaped strip (2 or 3), in particular a metal strip, that is helically wound with bellows-like turns (4 or 22), the wound-together layers formed by a strip width having singly hooked-together or multilayer interlocked edges (9; 19) joined by interfitting, welding, or a similar joining process, the strip (2 or 3) being preshaped by at least one roller pair outside the plane and being thereby deflected into an arcuate path with in both stretched and compacted condition fold height (h1 and h2) of the folds (4 and 22) equal to a multiple of the strip thickness, characterized in that
the folds (4 and 22) are made by connecting the edges of webs (5a and 5b) projecting radially from the trailing edge (10) of one turn and the leading edge (11) of another turn.

26. The method according to claim 25, characterized in that
the web edges are deformed and joined together at peaks (15).

27. The method according to claim 25, characterized in that
the web edges are thermally joined together at peaks (15).

28. The method according to claim 25, characterized in that
a bell-shaped inner fold (22) is wound in a valley of an outer fold (4) with diametrally extending webs (5b) projecting from a common bridge and connecting web (21).

29. The method according to claim 28, characterized in that
upper free web edges of the bell-shaped inner fold (22) are connected to adjacent web edges of the outer fold (4).

30. A conduit (1) for vibration-stressed piping systems, in particular as a motor-vehicle exhaust pipe, made from a preshaped strip (2 or 3), in particular a metal strip, that is helically wound with bellows-like turns (4 or 22), the wound-together layers formed by a strip width having singly hooked-together or multilayer interlocked edges (9; 19) joined by interfitting, welding, or a similar joining process, the folds (4 and 22) having heights (h1 and h2) equal to a multiple of a strip thickness, produced by the method of claims 1 to 5, characterized in that
each fold (4) is formed by webs (5a and 5b) projecting radially from the turns and having free edges that are connected gas-tight together at the peak (15).

31. The conduit according to claim 30, characterized in that
a tube-base forming strip (3) is formed with bell-shaped folds (22) that are each fitted in a fold of the other strip (2), free web edges of the outer fold (4) being joined at the peak (15) with the free edges of the inner adjacent webs (5b) of the bell-shaped fold (22) that covers the valley (16) of the outer fold (4) with a connecting region (21) between its webs (5b).

32. A conduit (1) for vibration-stressed piping systems, in particular as a motor-vehicle exhaust pipe, made from a preshaped strip (2 or 3), in particular a metal strip, that is helically wound with bellows-like turns (4 or 22), the wound-together layers formed by a strip width having singly hooked-together or multilayer interlocked edges (9; 19) joined by interfitting, welding, or a similar joining process, the folds (4 and 22) having heights (h1 and h2) equal to a multiple of a strip thickness, produced by the method of claims 1 to 5, characterized in that
each fold (4) is formed from a turn layer with a peak (15) of a preshaped closed turn and has a gas-tight interlock connection (9 or 19).
